(19) United States
(12) Patent Application Publication
(10) Pub. No.: US 2012/0231319 A1
(43) Pub. Date: Sep. 13, 2012

(54) STRUCTURAL AND THERMAL MANAGEMENT COMPONENT

(75) Inventors: Derrick Buck, Pendleton, IN (US); Bruce Silk, Indianapolis, IN (US)

(73) Assignee: EnerDel, Inc., Indianapolis, IN (US)

(21) Appl. No.: 13/508,772

(22) PCT Filed: Nov. 9, 2010
(86) PCT No.: PCT/US10/55889

§ 371 Date: May 9, 2012

Related U.S. Application Data
(60) Provisional application No. 61/259,488, filed on Nov. 9, 2009.

(51) Int. Cl. H01M 10/50; F28F 7/00

(52) U.S. Cl. 429/120; 165/185

(57) ABSTRACT

Structural and thermal management component. In at least one exemplary embodiment of a structural and thermal management component of the present disclosure, the component comprises a base portion defining an upper surface and a lower surface. An exemplary component further comprises a plurality of fins extending from the upper surface of the base portion at least substantially extending a length of the base portion, the plurality of fins configured to dissipate heat away from a structure positioned adjacent thereto, the plurality of fins and the base portion forming a structurally-rigid unitary body. In at least one embodiment, the structurally-rigid unitary body of the present disclosure is extruded from a single portion of a metal.

### CROSS REFERENCE TO RELATED APPLICATION

This International Patent Application claims the benefit of and incorporates by reference herein the disclosure of U.S. Provisional Patent Application Ser. No. 61/259,488, filed Nov. 9, 2009.

### BACKGROUND

Batteries are becoming increasingly important energy storage devices. Recently, battery packs that contain lithium ion batteries have become popular with automotive applications and various commercial electronic devices because they are rechargeable and have no memory effect. In order to be implemented in automotive applications and other devices, battery packs are typically supported and thermally managed by multiple parts. The parts used to support and thermally manage the battery packs typically take up a significant amount of space. In automotive applications, the space needed to accommodate a support structure and thermal management system is often not available or practical.

As mentioned above, battery packs typically require a thermal management system, in addition to a support system, to operate within a vehicle or other device. Significant temperature variances can occur from one cell of a battery to the next, which can be detrimental to the battery's performance. If one cell is at an increased temperature with respect to the other cells, its charge or discharge efficiency will be different, and, therefore, it may charge or discharge faster than the other cells. This will lead to a decline in the performance of the battery. To promote battery performance, the differential temperature between cells in the battery should be minimized. Therefore, batteries, such as lithium ion batteries, call for thermal management to maintain performance requirements.

Accordingly, there exists a need for a component that can serve as both a support system and a thermal management system.

### BRIEF SUMMARY

In at least one exemplary embodiment of a structural and thermal management component of the present disclosure, the component comprises a base portion defining an upper surface and a lower surface. An exemplary component further comprises a plurality of fins extending from the upper surface of the base portion at least substantially extending a length of the base portion, the plurality of fins configured to dissipate heat away from a structure positioned adjacent thereto, the plurality of fins and the base portion forming a structurally-rigid unitary body. In at least one embodiment, the structurally-rigid unitary body of the present disclosure is extruded from a single portion of a metal.

In various embodiments of a structural and thermal management component of the present disclosure, the component further comprises a housing extending from a first side of the base portion to an opposing second side of the base portion, the housing sized and shaped to encapsulate a battery pack when the battery pack is positioned about the component.

An exemplary structural and thermal management component of the present disclosure may further comprise a cooling block extending from the lower surface of the base portion and at least substantially extending a length of the base portion, wherein the cooling block is configured to provide additional structural rigidity to the body and wherein the cooling block defines one or more lumens extending a length of the cooling block, the one or more lumens configured to allow a liquid and/or a gas to flow therethrough.

In yet another exemplary embodiment of a structural and thermal management component of the present disclosure, the component comprises a base portion defining an upper surface, a lower surface, and one or more apertures at or near at least one perimeter edge of the base portion, the one or more apertures sized and shaped to receive a fastener therethrough. An exemplary embodiment further comprises a first plurality of fins extending from the upper surface of the base portion at least substantially extending a length of the base portion away from at least one perimeter edge of the base portion, the first plurality of fins configured to dissipate heat away from a structure positioned adjacent thereto. An exemplary embodiment comprises a second plurality of fins extending from the lower surface of the base portion at least substantially extending a length of the base portion, the second plurality of fins configured to dissipate heat from the base portion, the first plurality of fins, the second plurality of fins, and the base portion forming a structurally-rigid unitary body, wherein the structurally-rigid unitary body is extruded from a single portion of a metal. An exemplary embodiment further comprises a housing extending from a first side of the base portion to an opposing second side of the base portion, the housing sized and shaped to encapsulate a battery pack when the battery pack is positioned about the component.

In an exemplary embodiment of a battery system of the present disclosure, the battery system comprises a structural and thermal management component. In an exemplary embodiment, the component comprises a base portion defining an upper surface and a lower surface, and a plurality of fins extending from the upper surface of the base portion at least substantially extending a length of the base portion, the plurality of fins configured to dissipate heat from a battery positioned adjacent thereto, the plurality of fins and the base portion and forming a structurally-rigid unitary body, In an exemplary embodiment, the battery system further comprises a battery pack sized and shaped for placement adjacent to the component.

In an exemplary embodiment of a vehicle of the present disclosure, the vehicle comprises a structural and thermal management component. In exemplary embodiment, the component comprises a base portion defining an upper surface and a lower surface, and a plurality of fins extending from the upper surface of the base portion at least substantially extending a length of the base portion, the plurality of fins configured to dissipate heat from a battery positioned adjacent thereto, the plurality of fins and the base portion and forming a structurally-rigid unitary body. An exemplary embodiment of a vehicle of the present disclosure further comprises a battery pack sized and shaped for placement adjacent to the component, the component and the battery pack sized and shaped to fit within at least part of a vehicle.

In an exemplary embodiment of a method of forming a structural and thermal management component of the present disclosure, the method comprises extruding a single portion of a material to form a component. In an exemplary embodiment, the component comprises a base portion defining an upper surface and a lower surface, and a plurality of fins extending from the upper surface of the base portion at least substantially extending a length of the base portion, the plurality of fins configured to dissipate heat away from a structure positioned adjacent thereto, the plurality of fins and the base portion forming a structurally-rigid unitary body. In one embodiment, the method 800 may optionally include heating the single portion of material prior to extruding 806, cooling the material 820, and/or performing a secondary operation 830. A secondary operation may include one or more of the following: cutting the material, drilling through at least a portion of the material, and punching holes in the material.

### BRIEF DESCRIPTION OF THE DRAWINGS

Further advantages of the disclosure of the present application will become apparent upon reading the following detailed description in conjunction with the accompanying drawings, in which:

FIG. 1 shows a perspective view of a first embodiment of a structural and thermal management component, according to the present disclosure;

FIG. 2a shows a front view of a second embodiment of a structural and thermal management component, according to the present disclosure;

FIG. 2b shows a front view of a third embodiment of a structural and thermal management component, according to the present disclosure;

FIG. 3 shows a perspective view of a fourth embodiment of a structural and thermal management component, according to the present disclosure;

FIG. 4 shows a front view of the component of FIG. 3, according to the present disclosure;

FIG. 5 shows a side view of an exemplary embodiment of a base portion, according to the present disclosure;

FIG. 6 shows a front view of the component of FIG. 2a adjacent to a battery pack, according to the present disclosure;

FIG. 7 shows a front view of the component of FIG. 3 adjacent to a battery pack, according to the present disclosure; and

FIG. 8 shows a shows a diagram of a method for forming a structural and thermal management component according to an exemplary embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

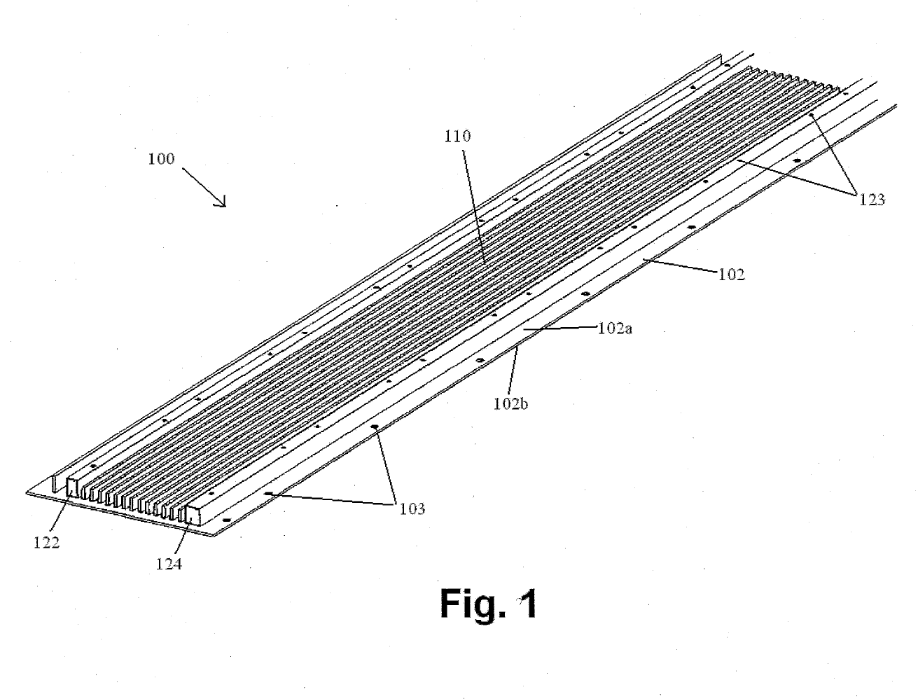

FIG. 1 shows an illustrative embodiment of a structural and thermal management component 100 of the present disclosure. The component 100 shown in FIG. 1 includes a base portion 102 that defines an upper surface 102a and a lower surface 102b. As shown in FIG. 1, base portion 102 may be rectangular-shaped. However, base portion 102 may be other shapes, such as, for example, square-shaped or circular-shaped. As shown in FIG. 1, base portion 102 may define apertures 103 between the upper surface 102a and the lower surface 102b. As shown in FIG. 1, the apertures 103 may be at or near the perimeter edge of the base portion 102. The apertures 103 may be configured to receive bolts or other fastener members, which can allow the component 100 to be secured to another structure. In an alternative embodiment, the base portion 102 may not include apertures 103. Regardless of whether or not the base portion 102 includes apertures 103, various securing means may be used to secure component 100 to another structure. The securing means may include, for example, welds, clamps, or opposing perimeter edges of the base portion 102 being configured to fit into slots of the other structure.

Component 100 may be secured to various types of structures including a vehicle. For example, in some electric vehicles, a battery system may be positioned where a drive shaft is normally located in a gas-powered vehicle. In such electric vehicles, the battery may be secured to the vehicle's chassis in the empty drive shaft space and stabilized therein using the component 100. When installed on the vehicle chassis, the upper surface 102a may face the vehicle while the lower surface 102b may face the road surface.

In at least one embodiment of a component 100 of the present disclosure, and as shown in FIG. 1, component 100 may include a plurality of fins 110 extending from the upper surface 102a of the base portion 102. As shown in FIG. 1, the fins 110 may have a substantially rectangular cross-section and extend a length of the base portion 102. The fins 110 are configured to dissipate heat away from a structure (e.g., a battery) that is positioned adjacent to the component 100. In at least one embodiment, air may be circulated about the fins 110 in order to facilitate the transfer of heat away from the structure. For example, component 100 may be secured and disposed within a vehicle such that the air traveling through the grill of the front of the vehicle provides circulation to the fins 110. It should also be noted that the air traveling underneath the vehicle may provide circulation to the fins 110. In another example, component 100 may be secured and disposed within a vehicle such that the air conditioning system of the vehicle provides air conditioned air flow about the fins 110.

An exemplary component 100, such as shown in FIG. 1, may further include first and second support blocks 122, 124 extending from the upper surface 102a of the base portion 102. As shown in FIG. 1, the fins 110 extending from the upper surface 102a may be between the first and second support blocks 122, 124. Of course, the support blocks 122, 124 may be positioned in other locations on the upper surface 102a. As shown in FIG. 1, support blocks 122, 124 may each define apertures 123 that extend at least partially through the respective block 122, 124. As described below, the support blocks 122, 124 are configured to support and secure the component 100 to a separate part, such as, for example, a battery.

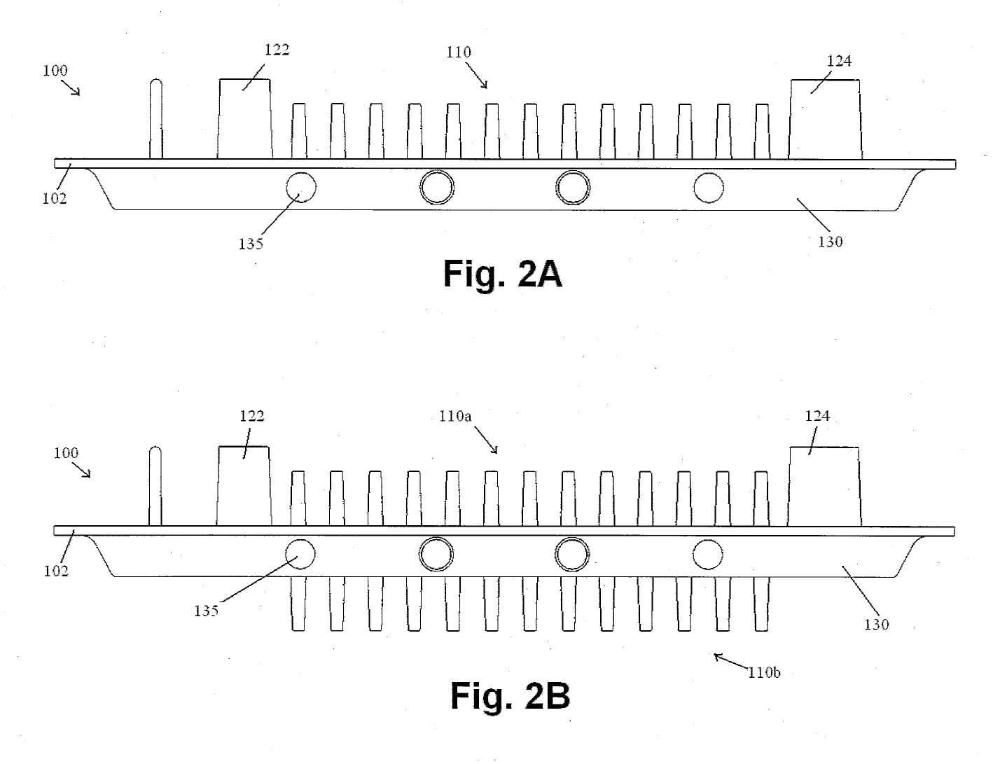

In an exemplary embodiment, a component 100 also includes a cooling block 130 that extends from the lower surface 102b of the base portion 102. As shown in FIGS. 2a and 2b, the cooling block 130 may include a substantially quadrilateral cross-section (e.g., isosceles trapezoid cross-section with smoothed edges) and may also include one or more lumens 135 that extend the length of the cooling block 130. The lumens 135 may be designed to be used to circulate water, glycol, air, or other thermal transfer medium so as to transfer heat away from the component 100.

As shown in FIG. 2b, in at least one embodiment, the component 100 includes a plurality of fins 110a extending from the upper surface 102a of the base portion 102 and a plurality of fins 110b extending from the cooling block 130. With this configuration, the fins 110a, 110b provide a large surface area in which to dissipate heat coming from an adjacent structure. It should also be noted that the set of fins closest to the structure with heat may generally absorb the heat and pass the heat via conduction through the base portion 102 to the other set of fins, where the heat is dissipated.

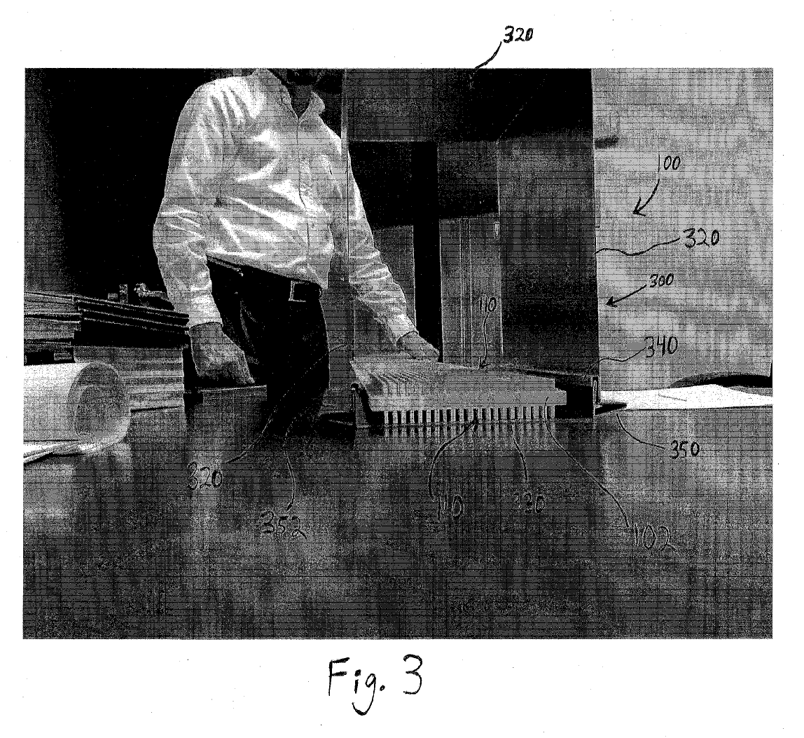

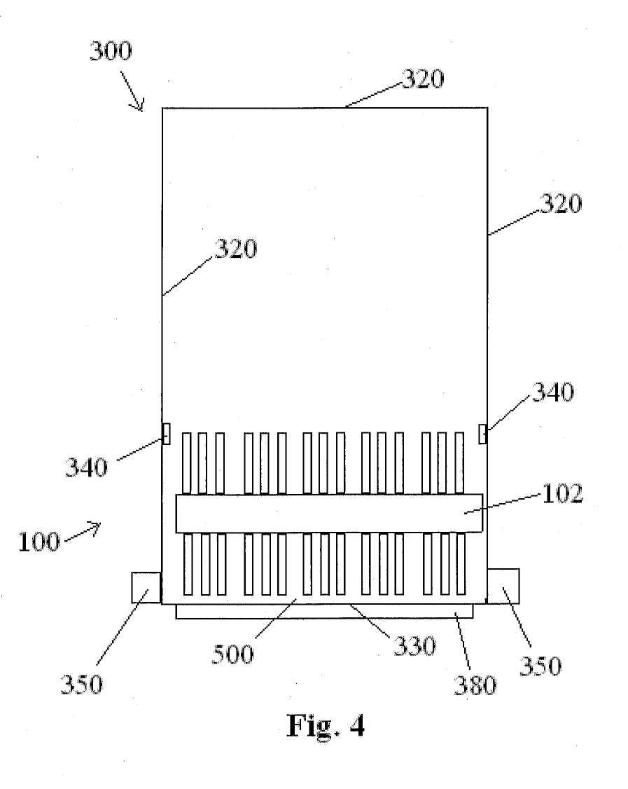

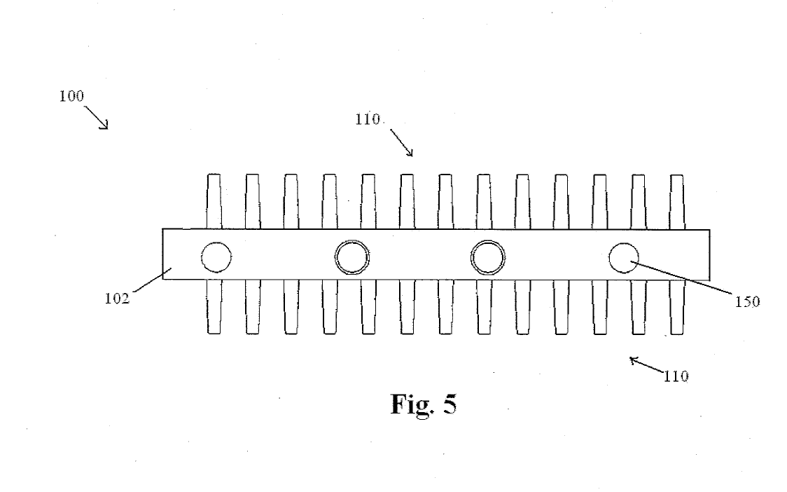

FIGS. 3 and 4 show another illustrative embodiment of a structural and thermal management component of the present disclosure. As shown in FIGS. 3 and 4, a component 100 includes a base portion 102 with a plurality of fins 110 on opposing sides of the base portion 102 and, optionally, a housing 300, where the base portion 102 is disposed within the housing 300. It should be noted that the base portion 102 shown in FIGS. 3 and 4 may be substituted for various other configurations. For example, the base portion 102 in FIG. 5, which includes one or more lumens 150, may also be utilized. The lumens 150 may be designed to be used to circulate water, glycol, or other thermal transfer medium so as to transfer heat away from the component 100.

The housing 300 may he sized and shaped to encapsulate a battery pack when the battery pack is positioned about the component 100. For example, the housing 300 shown in FIGS. 3 and 4 includes walls 320, 330 that are arranged to receive the base portion 102, as well as a battery pack above the base portion 102. The walls of the housing 320, 330 may have a length that is about as long as the base portion 102. As shown in FIGS. 3 and 4, the housing 300 may include inner flanges 340 that extend inward toward the base portion 102 and that are configured to support a battery positioned thereon.

A wall of the housing 320, 330 may define at least part of the underside of a vehicle. For example, the wall 330 may be the only structure between the base portion 102 and corresponding battery pack and the roadway beneath the vehicle. As shown in FIG. 4, the wall 330 and the lower surface 102b of the base portion 102 may define a space 500 therebetween in order to provide thermal protection for the battery pack from the roadway and underside of the vehicle. In one embodiment, as shown in FIG. 4, an insulating material 380 may be attached to the wall 330. The insulating material 380 may provide further thermal protection for the battery pack from external heat sources, such as, for example, hot asphalt.

As shown in FIGS. 3 and 4, the housing 300 may include one or more flange portions 350 that extend out away from the base portion 102. As shown in FIG. 3, the flange portions 350 may include one or more apertures 352. Apertures 352 may be configured to receive bolts or other fastener members, which may allow the component 100 to be secured to another structure. As noted previously, the component 100 may be secured to a vehicle or various electronic devices. In an alternative embodiment, the flange portions 350 may not include apertures 352. Regardless of whether or not the flange portions 350 include apertures 352, various securing means may be used to secure the component 100 to another structure, such as, for example, welds, clamps, or by inserting the flange portions 350 into slots of the other structure. The component 100 may also include stabilizing parts (not shown) configured to be placed between the base portion 102 and a wall 320, 330 of the housing 300 such that the base portion 102 is substantially immovable relative to the housing 300. The stabilizing parts may include a metal spacer or other part configured to immobilize the base portion 102.

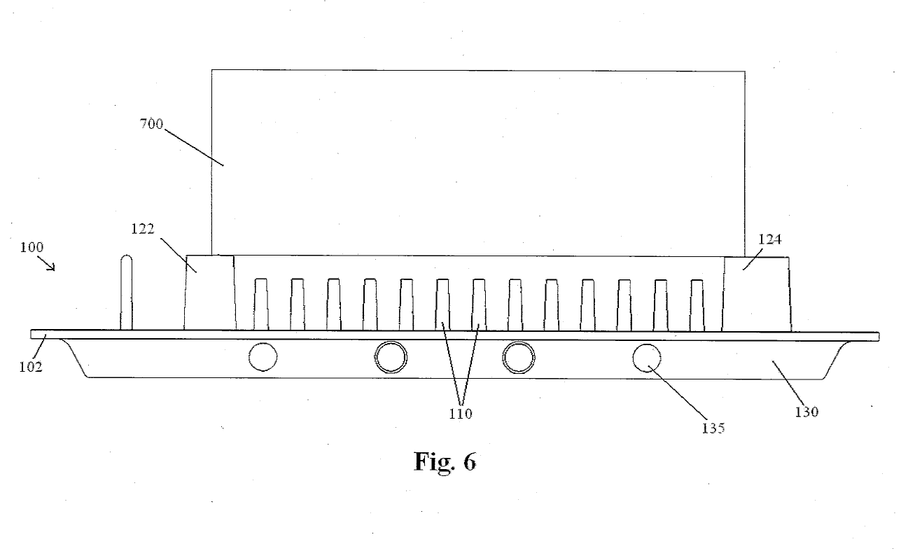

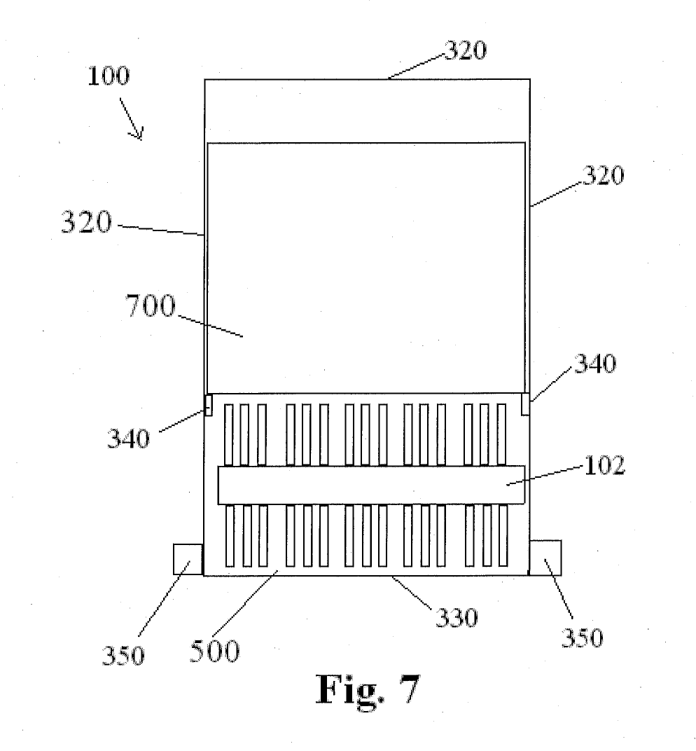

In one embodiment, a battery pack 700 may be placed adjacent to the component 100 such that the component 100 provides relative stability for the battery pack 700 and assists in cooling the battery pack 700. For example, a component 100 and a battery pack 700 may each be sized and shaped to allow the battery pack 700 to be on top of the component 100. The battery pack 700 in FIG. 6 is shown as being placed on top of the support blocks 122, 124, such that the battery pack 700 sits above the plurality of fins 110 that extend from the upper surface 102a of the base portion 102. In an alternative embodiment, as shown in FIG. 7, the battery pack 700 is placed on top of the inner flanges 340 within the housing 300. With the battery pack 700 adjacent to the component 100, the base portion 102 and the fins 110 that extend from the upper surface 102a of the base portion 102 absorb the heat given off by the battery pack 700. In regards to the configuration of FIG. 6, it should be noted that the support blocks 122, 124 may also absorb heat from the battery pack 700. In regards to the configuration of FIG. 7, it should be noted that the housing 300 may also absorb heat from the battery pack 700.

At least part of the heat absorbed by the component 100 from the battery pack 700 may be dissipated across the surface area of the fins 110 that extend from the upper surface 102a. Of course, at least a part of the heat absorbed by the component 100 would also be dissipated across the surface area of the fins 110 that extend from the lower surface 102b or the cooling block 130, if such second set of fins 110 is present. As mentioned above, air or another fluid may be circulated about the fins 110 to facilitate transferring heat away from the battery pack 700. Also, at least part of the heat absorbed by the component 100 from the battery pack 700 is transferred away from battery pack 700 and component 100 by being absorbed by the fluid flowing through the lumens 135 of the cooling block 130 or lumens 150 of the base portion 102. In other words, the fluid (e.g., water or air) flowing through the lumens 135, 150 can absorb the heat from the component 100 and carry it away from the component 100. The lumens 135, 150 may be connected to tubes that circulate air from a fan, cold air from an air conditioning unit, cold water from a water supply, and/or various other sources of thermally conductive medium. Alternatively or in addition, the lumens 135 may simply receive air from the exterior environment as the system (e.g., vehicle) moves from one place to another. It should be noted that other portions of the structures referenced herein (e.g., housing 300) may also dissipate heat away from the battery pack 700, such as across the surface are of the respective portion.

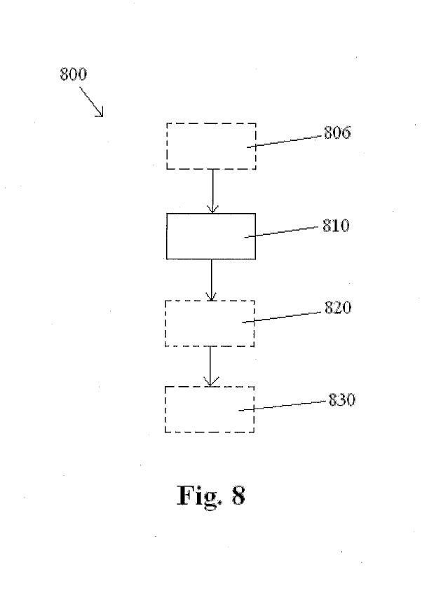

As shown in FIG. 8, a method of forming a structural and thermal component 800 is provided. The method 800 includes extruding a material to form any number of components 100 referenced herein 810. As discussed above, the material may include various types of metals including, for example, steel and aluminum but may include other high-strength materials. By extruding a single piece of material, component 100 is formed as a structurally-rigid unitary body. It should be noted that the extrusion step 810 may comprise direct extrusion or indirect extrusion. In at least one embodiment, the base portion 102 and fins 110 (and, if applicable, the cooling block 130 and support blocks 122, 124) may be extruded from a single piece of material, while the housing 300 may be formed separately. In an alternative embodiment, component 100 may be formed by machining one or more individual parts and attaching the separate parts together. The method 800 in FIG. 8 may optionally include heating the single portion of material prior to extruding 806. After the extrusion step 810, the method 800 may optionally include cooling 820, such as, for example, applying water or air to the extruded material or contacting the extruded material with a cold surface. The method 800 may also optionally include performing a secondary operation 830. A secondary operation may include one or more of the following: cutting the material, drilling through at least a portion of the material, and punching holes in the material. As noted above, the steps of the method 800 are followed to form any number of structural and thermal components 100 referenced herein.

While various embodiments of a structural and thermal management component have been described in considerable detail herein, the embodiments are merely offered by way of non-limiting examples of the disclosure described herein. It will therefore be understood that various changes and modifications may be made, and equivalents may be substituted for elements thereof, without departing from the scope of the disclosure. For example, any number of components 100 referenced herein may have one or more features/configurations of another component 100 referenced within the present disclosure. Indeed, this disclosure is not intended to be exhaustive or to limit the scope of the disclosure.

Further, in describing representative embodiments, the disclosure may have presented a method and/or process as a particular sequence of steps. However, to the extent that the method or process does not rely on the particular order of steps set forth herein, the method or process should not be limited to the particular sequence of steps described. Other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A structural and thermal management component, comprising;
a base portion defining an upper surface and a lower surface; and
a plurality of fins extending from the upper surface of the base portion at least substantially extending the length of the base portion, the plurality of fins configured to dissipate heat away from a structure positioned adjacent thereto, the plurality of fins and the base portion forming a structurally-rigid unitary body.

2. The component of claim 1, wherein the structurally-rigid unitary body is extruded from a single portion of a metal.

3. (canceled)

4. The component of claim 1, further comprising:
a cooling block extending from the lower surface of the base portion and at least substantially extending the length of the base portion.

5. The component of claim 4, wherein the cooling block is configured to provide additional structural rigidity to the body.

6. The component of claim 4, wherein the cooling block defines one or more lumens extending a length of the cooling block, the one or more lumens configured to allow a liquid and/or a gas to flow therethrough.

7. (canceled)

8. The component of claim 1, further comprising:
at least one support block extending from the upper surface of the base portion and at least substantially extending a length of the base portion, the at least one support block configured to provide additional structural rigidity to the body.

9. The component of claim 8, wherein the at least one support block comprises two support blocks, and wherein the plurality of fins extend from the base portion in between the two support blocks.

10. The component of claim 1, wherein the plurality of fins extend from the upper surface away from at least one perimeter edge of the base portion.

11. The component of claim 10, wherein one or more apertures are defined within the base portion at or near the at least one perimeter edge, the one or more apertures sized and shaped to receive a fastener therethrough.

12. (canceled)

13. The component of claim 1, further comprising:
a housing extending from a first side of the base portion to an opposing second side of the base portion, the housing sized and shaped to encapsulate a battery pack when the battery pack is positioned about the component.

14. The component of claim 13, wherein the housing extends above the upper surface of the base portion and below the lower surface of the base portion.

15. The component of claim 13, wherein the housing further comprises at least two flanges, the at least two flanges configured to support the battery pack positioned thereon,

16. (canceled)

17. A structural and thermal management component, comprising:
a base portion defining an upper surface, a lower surface, and one or more apertures at or near at least one perimeter edge of the base portion, the one or more apertures sized and shaped to receive a fastener therethrough;
a first plurality of fins extending from the upper surface of the base portion at least substantially extending the length of the base portion away from at least one perimeter edge of the base portion, the first plurality of fins configured to dissipate heat away from a structure positioned adjacent thereto;
a second plurality of fins extending from the lower surface of the base portion at least substantially extending the length of the base portion, the second plurality of fins configured to dissipate heat from the base portion, the first plurality of fins, the second plurality of fins, and the base portion forming a structurally-rigid unitary body, wherein the structurally-rigid unitary body is extruded from a single portion of a metal; and
a housing extending from a first side of the base portion to an opposing second side of the base portion, the housing sized and shaped to encapsulate a battery pack when the battery pack is positioned about the component.

18. The component of claim 17, wherein the base portion further defines one or more lumens extending a length of the base portion, the one or more lumens configured to allow a liquid and/or a gas to flow therethrough.

19. The component of claim 17, wherein the housing further comprises at least two flanges, the at least two flanges configured to support the battery pack positioned thereon.

20. A battery system, comprising:
a structural and thermal management component, comprising:
a base portion defining an upper surface and a lower surface, and a plurality of fins extending from the upper surface of the base portion at least substantially extending the length of the base portion, the plurality of fins configured to dissipate heat from a battery positioned adjacent thereto, the plurality of fins and the base portion and forming a structurally-rigid unitary body; and
a battery pack sized and shaped for placement adjacent to the component.

21. The battery system of claim 20, further comprising:
a housing extending from a first side of the base portion to an opposing second side of the base portion, the housing sized and shaped to encapsulate the battery pack.

22. The battery system of claim 21, wherein the housing further comprises at least two flanges, the at least two flanges configured to support the battery pack positioned thereon.

23. The battery system of claim 21, further comprising:
a cooling block extending from the lower surface of the base portion and at least substantially extending the length of the base portion, wherein the cooling block is configured to provide additional structural rigidity to the body.

24. The battery system of claim 23, wherein the cooling block defines one or more lumens extending a length of the cooling block, the one or more lumens configured to allow a liquid and/or a gas to flow therethrough.

25-33. (canceled)
